(19) United States
(12) Patent Application Publication
(10) Pub. No.: US 2019/0060945 A1
(43) Pub. Date: Feb. 28, 2019

(54) Coating method, coating apparatus for carrying out this method and coating unit with such a coating apparatus

(71) Applicant: Forplan AG, Brugg (CH)

(72) Inventors: Bruno Forster, Studen (CH); Walter A. Forster, Sutz-Lattringen (CH); Adrian Forster, Orpund (CH); Michael Römer, Rottweil (DE)

(73) Assignee: Forplan AG, Brugg (CH)

(21) Appl. No.: 16/058,442

(22) Filed: Aug. 8, 2018

(30) Foreign Application Priority Data
Aug. 9, 2017 (DE) 10 2017 118172.5

(51) Int. Cl. B05C 3/09; B05C 11/11; B05D 1/18; B05D 1/00; B05C 13/00

(52) U.S. Cl. CPC B05C 3/09; B05C 11/11; B05C 13/00; B05D 1/002; B05D 1/18

(57) ABSTRACT

A coating method is provided with the steps of dipping of containers filled with the parts to be coated, having a pierced container wall, into a section of a reservoir filled with a coating liquid, lifting the containers filled with the parts to be coated out from the coating liquid and dispersing and/or spinning off the excess coating liquid remaining on the parts being coated after they are lifted out. During dispersing and/or spinning, the container filled with the parts being coated is rotated about an axis of rotation situated inside the container filled with the parts being coated and at least for a time about an axis of rotation situated outside the container and running parallel to the axis of rotation situated inside the container.

The invention relates to a coating method with the features of the preamble of patent claim 1, a coating device to implement such a method, and a coating lay-out with such a coating device.

A variety of components are usually provided with a surface coating. Especially in the case of small parts, such as screws or nuts, this surface coating is often done by dipping into a liquid coating agent or one dissolved in a liquid—hereinafter subsumed under the term “coating liquid”—but this is not done individually for each single small part. Instead, the small parts are usually filled as bulk goods into a container with pierced container walls, such as a basket, which is then dipped into the liquid. By revolving the small parts, it is ensured that no untreated contact surfaces remain on the small parts. Excess liquid is then spun off from the small parts outside of the liquid. Examples of such coating methods and devices for their implementation are known, for example, from DE 199 31 663 C1 or EP 2 913 284 A1.

In many cases, the small parts being coated have depressions, such as threads. It turns out that in these cases the known coating methods, working by the principle just described, result in an unwanted high rate of rejects, especially because coating agent is not adequately removed from depressions of the small parts during the conventional spin-off and/or because the formation of air inclusions means that the liquid used for the coating cannot spread out to all places of the small part, that the small part remains uncoated in places.

Therefore, the problem which the invention proposes to solve is to provide an improved coating method, especially in terms of its reliability and efficiency, a coating device to implement this method, and a coating layout with such a coating device.

This problem is solved by a coating method with the features of patent claim 1 and a coating device with the features of patent claim 7 and a coating layout with the features of patent claim 11. Advantageous modifications of the method are the subject matter of the dependent patent claims.

The coating method according to the invention has the following steps, in particular:
dipping of containers filled with the parts to be coated, having a pierced container wall, into a reservoir filled with a coating liquid,
lifting the containers filled with the parts to be coated out from the coating liquid and
dispersing and/or spinning off the excess coating liquid remaining on the parts being coated after they are lifted out

According to the invention, during the dispersing and/or spinning off of excess coating liquid remaining on the parts being coated after they are lifted out, the container filled with the parts being coated is rotated at least for a time about an axis of rotation situated inside the container filled with the parts being coated and at least for a time about an axis of rotation situated outside the container filled with the parts being coated and running parallel to the axis of rotation situated inside the container filled with the parts being coated. Advantageously, the axis of rotation situated inside the container is a central axis of the container, if it is shaped such as to have a central axis.

This procedure results in significantly improved outcomes, especially in regard to an effective draining of internal recesses. It has the effect that a rearranging of the parts being coated occurs during the spinning off of excess coating liquid and furthermore it brings about a superimposing of centrifugal forces of the two rotations so that the direction in which the resultant force is acting relative to the position of a part being coated in the container is independent of time, which increases the efficiency of the spinning off and helps to prevent air inclusions.

Preferably also while the container filled with the parts to be coated is being dipped into the coating liquid, the container filled with the parts to be coated is rotated at least for a time about the axis situated inside the container filled with the parts being coated and/or at least for a time about the axis situated outside the container filled with the parts being coated and running parallel to the axis situated inside the container filled with the parts being coated. This results in a “rolling” of the parts being coated. As a result of this intensified rearrangement of the parts being coated in the container, the likelihood is significantly decreased that portions of the surface of a part being coated will not be wetted with coating liquid.

These advantageous effects become especially significant when the container filled with the parts to be coated is rotated at least for a time simultaneously about the axis situated inside the container filled with the parts being coated and about the axis situated outside the container filled with the parts being coated and running parallel to the axis situated inside the container filled with the parts being coated. Furthermore, the time efficiency of the process is improved.

Especially advantageously, direction and speed of rotation about the axis situated inside the container filled with the parts being coated and direction and speed of rotation about the axis situated outside the container filled with the parts being coated are controlled independently of each other. This brings two advantages: first of all, the specific setting of these parameters can influence the resulting layer thickness in specific manner. Secondly, this allows an adjusting of the rotary movements in the submerged and in the lifted-out state independently of each other. For an optimization of the required volume of coating agent and the mechanical load distribution, there are advantageously present two containers filled with the parts being coated, which are arranged jointly on the rotor, the axis situated inside the container filled with the parts being coated is the center axis of the respective container, and the axis situated outside the container filled with the parts being coated is a center axis of the rotor which is equidistant from the two center axes.

This arrangement in particular allows the coating agent to be provided only in a gutter of the reservoir, so that the need for coating agent is minimized. This can produce substantial cost savings by reducing the throughput of coating agent, especially when the material is unstable and/or the mixture has a tendency to separate, so that it must be replaced often.

Basically, the possibility also exists to select another symmetrical arrangement of the container with respect to the center axis of a rotor—possibly one outfitted with a corresponding number of rotor blades—but this means that a larger reservoir will be needed for the coating agent.

It may be advantageous for the rotor with the containers arranged thereon to be tilted, especially during the dipping, at least for a time about an axis of rotation parallel to the floor surface, so that the axis of rotation about which the containers are turned is slanted.

Preferably the dipping of containers filled with the parts to be coated into the section of the reservoir filled with a coating liquid occurs by a lifting movement of the reservoir.

The coating device according to the invention for implementing such a coating method has at least one container filled with the parts to be coated, having a pierced container wall, which is mounted hanging in a holder such that it can be rotated by a first drive unit about an axis situated inside the container filled with the parts being coated, and moreover it has a reservoir for a coating liquid, into which containers filled with the parts to be coated can be dipped.

According to the invention, the holder in which the container filled with the parts to be coated is hanging is arranged on a rotor, which can be rotated by a second drive unit, independent of the first drive unit, about an axis of rotation situated outside the container filled with the parts being coated and running parallel to the axis of rotation situated inside the container filled with the parts being coated. This ensures that the two rotational movements required for the method according to the invention can be performed by the coating device.

Preferably, the mount of the containers allows for a replacing of the containers, i.e., a fixation mechanism for the containers is present, which enables a mount and a removing of the containers, even if they are full. When implementing the coating method, filled containers are preferably arranged on the coating device and removed from it after the coating process, instead of what was often formerly done, namely, filling the containers firmly arranged on the coating device with parts to be coated, and emptying them after the coating process.

For a good distribution of the mechanical loads, preferably two containers filled with the parts to be coated are present, being arranged jointly on the rotor, the axis situated inside the container filled with the parts being coated is the center axis of the respective container, and the axis situated outside the container filled with the parts being coated is a center axis of the rotor which is equidistant from the two center axes of the containers filled with the parts being coated.

Moreover, especially preferably the rotor is arranged rotatably on a carrier structure, which can swivel about an axis running parallel to the floor. For example, this makes it possible to reduce the volume of the reservoir for the coating liquid; furthermore, it becomes possible in this way to also utilize the influence of gravity for rearrangement processes and/or for dispersing or spinning off of coating liquid.

Moreover, preferably the height at which the reservoir is situated relative to the floor can be changed by moving the reservoir.

The holder is preferably designed as a clamping mechanism, which especially preferably comprises a drive unit, which may preferably be designed as a pneumatic drive unit, and a sensor.

The coating layout according to the invention comprises a filling device for the filling of containers filled with the parts to be coated, a coating device for the coating of the parts to be coated by dipping the containers filled with the parts to be coated into a coating liquid and spinning off the excess coating liquid, an emptying device for emptying the containers filled with the now coated parts, and a container handling system for the transport of the containers between and for handing off the containers to the devices belonging to the coating layout.

It is distinguished in that the coating device is a coating device as just explained, which means in particular that the coating layout produces parts with improved coating and fewer rejects.

Especially good results are achieved when the coating layout also additionally comprises a drying device, in which the parts can be dried and evaporated after the coating process.

It has proven to be especially advantageous when the devices belonging to the coating layout are arranged in a circle around the container handling system.

It should be emphasized that, although an automated process control with high throughput and optimized efficiency can be realized with such a coating layout, the coating process can also of course be done with only one coating device, by manually performing the container filling and emptying.

The invention shall now be explained more closely with the aid of figures, showing sample embodiments. There are shown:

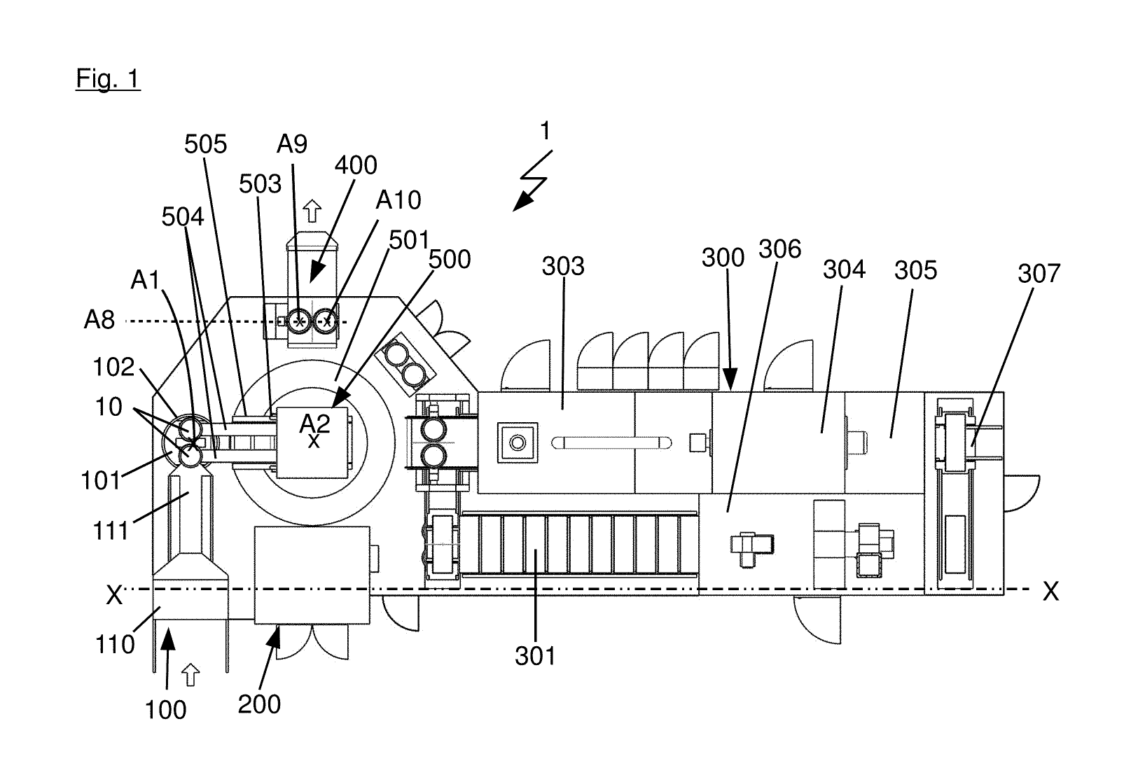

FIG. 1: A schematic overview of a coating layout in frontal view;

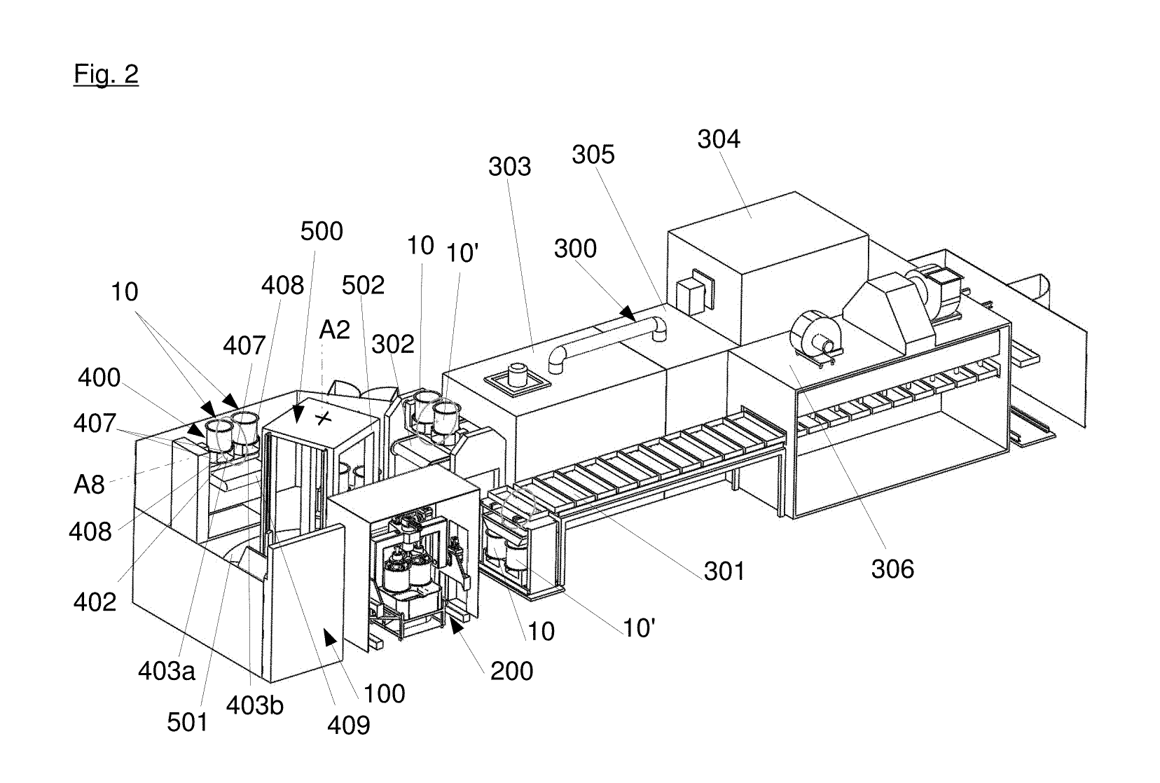

FIG. 2: a 3D view of the coating layout of FIG. 1, being sectioned along line X-X;

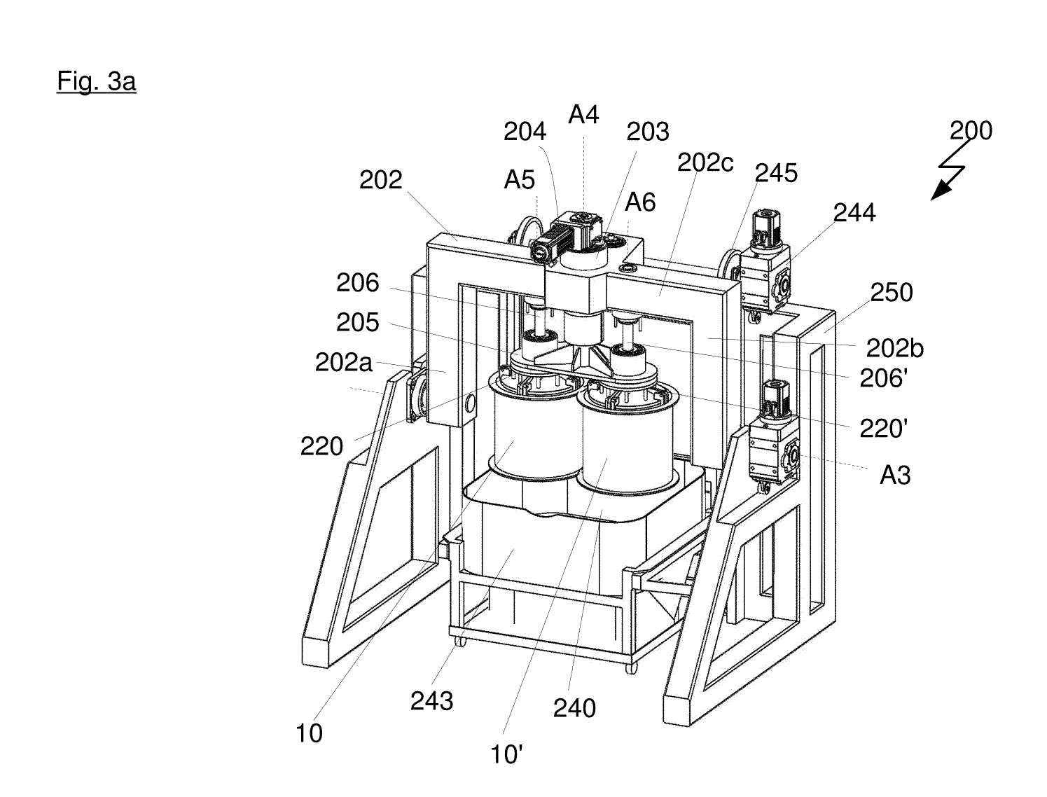

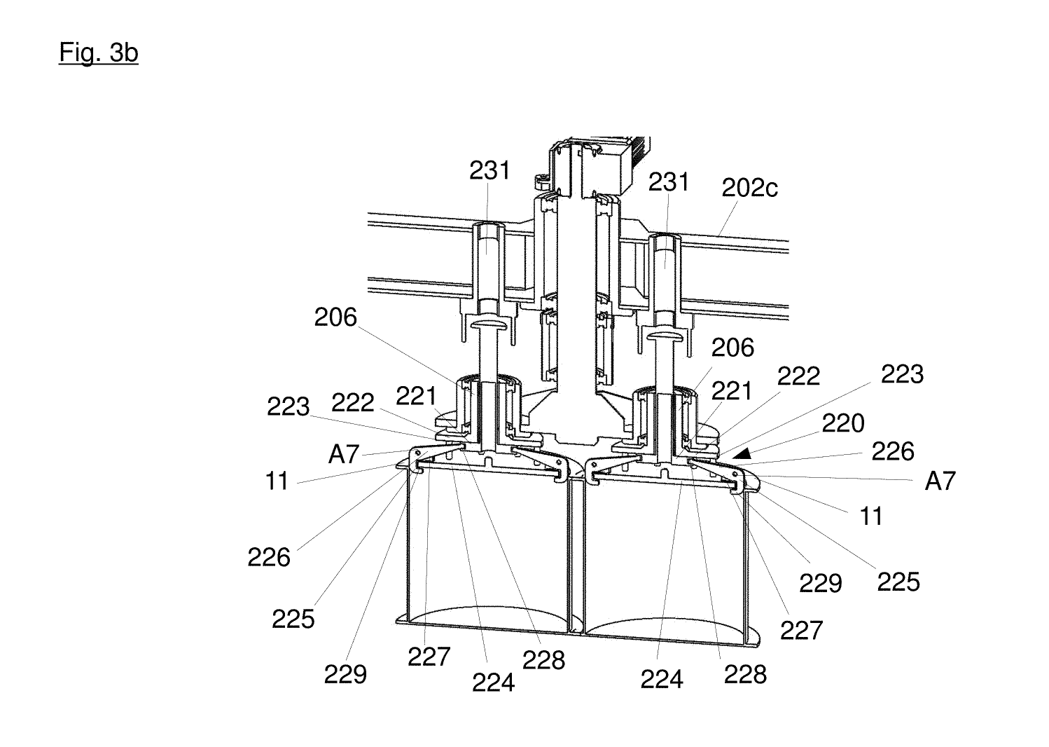

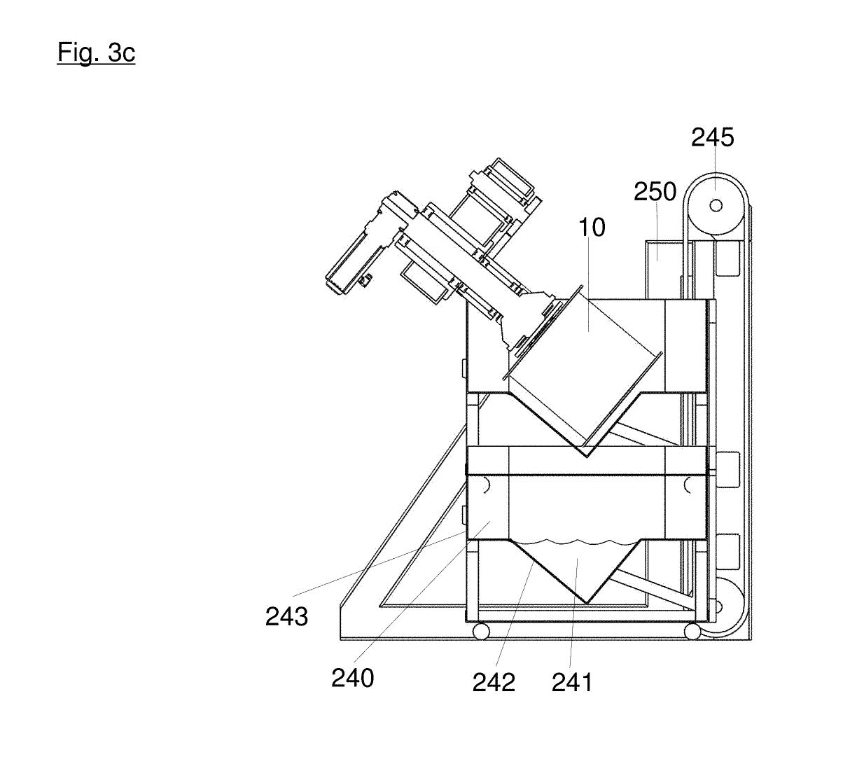

FIG. 3a: a view of a coating device

FIG. 3b: a detail representation of an automated clamping device for the containers, optionally present on the coating device,

FIG. 3c: a cross section through the coating device of FIG. 3a

In order to keep the reference numbers within manageable bounds, not all reference numbers are shown in all the figures. Since the figures involve partial aspects of the same embodiment of the invention, the same reference numbers are used in different figures.

FIG. 1 shows a schematic overview looking at a coating layout 1 with
a filling device 100 for the filling of containers to be filled with parts to be coated,
a coating device 200 for coating the parts to be coated by dipping the containers filled with parts to be coated into a coating liquid and spinning off of excess coating liquid,
a drying device 300 for drying and evaporating of coated parts,
an emptying device 400 for emptying o containers filled with now coated parts, and
a container handling system 500 for the transport of the containers between and the hand-off of the containers to the devices belonging to the coating layout 1.

FIG. 2 shows a 3D view of the coating layout of FIG. 1, sectioned along line X-X.

The individual devices and their function shall be explained in detail in the following. It is pointed out already now that the overall coating layout is designed for a parallel processing of two containers with parts being coated, which enables an especially efficient application.

The filling device 100, coating device 200, drying device 300 and emptying device 400—more precisely, the container or container receiving positions of these devices indicated by circles—are arranged roughly in a circle about the container handling system 500 for the transport of the containers between and for the hand-off of the containers to the devices belonging to the coating layout 1. The circular arrangement of the components about the central container handling system 500 enables a flexible layout and a flexible process control.

Thus, for example, for fast drying coatings where a further drying or a temperature increase for the drying is not necessary, a transfer from the coating device 200 to the emptying device 400 is possible without necessarily going through the drying device 300.

But it is also easy to perform a multiple coating in that the container with parts having already received a first coating, after moving through the drying device 300, is once again placed by the container handling system 500 in the container receiving position 201 of the coating device 200.

It should further be noted that, as is described more closely below as a variant, it is also possible to remove the parts from the containers 10 before the drying. In particular, for such a plant layout, the emptying device 400 may then be arranged in front of the drying device 300 and/or load it with parts emptied from the containers 10.

The filling device 100 has a bin 110, only part of which is shown, having a stockpile of the parts to be coated, which can be designed for example as a vibration bin, with a discharge port 111 swiveling optionally together with the bin 110 or separately from the bin 110, from which the parts slide down when the bin 110 is opened.

In order to position the containers 10 with perforated container wall, designed here as baskets, relatively to the discharge port 111—possibly across an optional funnel, not shown here, arranged between discharge port 111 and container 110—so that they can be filled, the filling device 100 comprises an E-shaped (for example) container receiving position 101, in which two containers 10 with perforated container wall are placed alongside each other on the cross beams of the E-shaped container receiving position 101 (i.e., on the cross beams of the letter E).

The container receiving position 101 is arranged on a plate 102, which is connected to a support column, mounted in a foot and able to rotate by an angle of a least 180° about an axis of rotation A1—preferably being motor driven—so that each of the two containers 10 can be arranged for their filling beneath the discharge port 111 or the funnel when the E-shaped container receiver 101 is rotated by 180°.

In addition, the use of a lifting and tilting apparatus, not shown, is preferably possible, which by moving the bin assists in the entry of the parts being coated into the discharge port 111 or the funnel.

One result of the arrangement of the containers 10 on the legs of an E-shaped container receiving position 101 is that there are clearances between the bottom of the container 10 and the plate 102, which simplify the transport of the containers 10 by the container handling system 500, as will be further described below.

The opening of the bin 110 is preferably controlled by a weighing device with residual quantity optimization, not shown.

Accordingly, when carrying out the coating method according to the invention, in the event that the coating layout 1 described here is used, a step for automated loading of the containers with the parts to be coated is carried out, and the parts to be coated are handled like bulk goods.

Next, the containers 10 filled with the parts to be coated have to be transported to the coating device 200. This is done—just like the further transport steps, described below—by means of the container handling system 500, which is the next to be described, especially with reference to FIGS. 1 and 2.

The container handling system 500 comprises a frame 502 mounted on a foot 501 and able to turn about an axis of rotation A2 running vertically to the floor level—preferably driven by a motor—on which is arranged a height-adjustable mount 503—preferably driven by a motor—for two container carriers 504.

The container carriers 504 can travel in or on this mount 503—preferably driven by a motor—in a direction parallel to the floor level. As can be especially well seen in FIG. 1b, they are configured such that their extension in the plane situated parallel to the floor level in a direction perpendicular to the travel direction of the container carrier 504 is smaller than the distance between the cross beams of the E-shaped container receiving position 101 and they have a surface running parallel to the floor level which is wide enough for a container 10 to easily stand thereupon.

This configuration of the container handling system 500 makes it possible to use the container carrier 504 for transport, similar to the teeth of a forklift truck, by introducing the container carrier 504 into the clearances and then lifting it to receive the container 10, move to another device of the coating layout 1, and hand it off there to a corresponding container receiving position of the respective device.

While the degrees of freedom of movement described thus far in a circular arrangement of the devices belonging to the coating layout 1 are adequate, if a different arrangement of these devices in the layout is desired it may also be accomplished if the foot 501 is movable—for example, on a rail system 505.

Optionally, the possibility may also be provided of moving the relative distance between the two container carriers 504. This allows a greater flexibility in the configuration of the container receiving positions of the respective devices.

Typically, the containers 10 filled with parts to be coated are then handed off to the coating device 200, which shall now be described with the aid of FIGS. 3a to 3d.

The coating device 200 comprises, as can be especially well seen in the representation of FIG. 3a, a stand 250 as the carrier structure for a frame 202 with two side pieces 202a, 202b, which stand perpendicular to a middle beam 202c connecting them, which in the embodiment represented can swivel about an axis of rotation A3 running horizontal to the floor, the swivel angle being preferably +/−50° relative to the upright position of the frame 202, in which the side pieces 202a, 202b extend vertically, starting from the middle beam 202c, in the direction of the floor. The frame 202 is thus mounted in the stand 250 and can swivel about the axis of rotation A3, a motor 251 being shown in this sample embodiment to execute the swivel movement in the representation of FIG. 3a.

On the middle beam 202c there is rotatably mounted an axle 203, defining an axis of rotation A4 and running parallel to the side pieces 202a, 202b of the frame 200, and which can be driven by a motor 204. At the end of the axle 203 facing away from the middle beam 202c, a rotor 205 is connected to the axle 203, on which are arranged two suspended holders 220, 220′, symmetrically to the axle 203 and able to turn about a respective axle 206, 206′defining the axis of rotation A5, A6, for containers 10, 10′ represented only schematically in FIG. 4a, the axle 206, 206′ being attached at the center of these holders 220, 220′ and the position of the axles 206, 206′ being chosen such, and the holders 220, 220′ and container 10 being configured such, that the axis of rotation A4, which is defined by the axle 203, runs outside the containers 10, 10′ and the holders 220, 220′.

Thanks to this design, it is possible to rotate the containers 10, 10′ together with the rotor 205 about the axis of rotation A4 situated outside the containers 10, 10′ and additionally about the axis of rotation A5, A6 situated inside the container and defined by the axles 206, 206′.

One possible construction of the holders 220 shown in FIG. 3a shall be described below.

At the end of the axles 206, 206′ situated above the rotor and facing toward the middle beam 202c there is arranged a respective driving wheel 208, 208′, by which the axles 206, 206′ and thus the holders 220, 220′ can be driven in rotation, for example, by a toothed belt, not shown, which is driven by a gear wheel 210, arranged on the axle 203 and able to turn relative to it, which is driven by a further toothed belt with a pinion of a further motor, arranged on the middle section 202c of the frame 202. Of course, instead of toothed belts one may also use a transmission with gear wheels.

Furthermore, the coating device 200 also comprises, as can be seen e.g. in FIG. 3a, a reservoir 240 for the coating liquid 241. The lower area of the reservoir 240 is formed by a receiver 242 for the coating liquid 241, the upper area of the reservoir 240 by an encircling spray protection wall 243. The reservoir 240 is height-adjustable—preferably driven with a motor 244 and a drive mechanism 245.

The reservoir 240 is lowered far enough for the placing of the containers 10, 10′ on the holders 220, 220′ or the removal of them from the holders so that the containers 10, 10′ are accessible from the side. After installing the containers 10, 10′ filled with the parts to be coated, the reservoir 240 is raised far enough so that the containers 10, 10′ dip into the receiver 242 for the coating liquid 241 and optionally a movement of the containers 10, 10′ is carried out to ensure a uniform wetting of the parts to be coated with coating liquid 241. After this, the reservoir 240 is lowered far enough so that the containers 10, 10′ are arranged outside of the coating liquid 241, but still entirely within the surrounding spray protection wall 243, and the step of dispersing and spin-off can commence.

When this step is completed, the reservoir 240 is lowered further in order to allow free access of the container handling system 500.

As can be easily appreciated with the aid of the example shown in FIG. 3c, thanks to the degrees of freedom of movement of the containers 10, 10′ afforded by the coating device 200, the receiver 242 for the coating liquid 241 can be very much smaller in its dimensions and can be configured as a gutter-like recess in the round basin, defined by the surrounding spray protection wall 243, which can have a V-shaped or rectangular cross section. This results in an especially efficient utilization of the coating liquid 241.

Finally, with the aid of FIG. 3b an especially advantageous realization possibility for a holder 220 shall be described in detail. This holder 220 comprises an actuating element 221, which passes through the axle 206, to which the holder 220 is connected via a first plate 222 at the end of the axle 206 facing toward the reservoir 230, in the inside of the axle 206.

The first plate is connected by struts 223 to a second plate 224, on which retaining brackets 225 are arranged about respective axes of rotation A7, parallel to the second plate 224, so that they have an actuating section 226 on one side of the axis of rotation A7, which is braced across compression springs 227 against the plate 224 and can be actuated by an end section 228 of the actuating element 221 against the pressure of the compression springs 227. On the other side of the axis of rotation A7 they have a hook-shaped section 229, which when the actuating section 226 is not actuated engages across a peripheral edge 11 of the container 10 so that the container is firmly held and secured on the holder 220.

For the actuating of the actuating section 226, the rotor 205 is moved into a position in which the actuating element 221 can be actuated by an actuating device 230 provided on the middle beam 202c. For example, for the actuating of the actuating element 221, this can pneumatically press down a rain passing through the middle beam 202c in the openings 231, which then pushes the actuating element downward, overcomes the opposing pressure of the compression springs 227, and thereby moves the actuating section 226 downward, so that the hook-shaped section 229 is moved into a release position, in which the container 10 can be inserted or removed by the container handling system 500.

After the coating has been placed on the parts to be coated with the coating device 200, these parts may be optionally dried by a drying device 300 and evaporated off. One example of such a drying device 300 shall now be described with the aid of FIGS. 1 and 2.

The drying device 300 has a plurality of trays 301, which alternatively to the depicted form may also be divided into two halves. The containers 10, 10′ may be emptied—for example, with an emptying device 400, as is described below, or in another manner—after they have been handed off by the container handling system 500 to the drying device 300, and this either on wire mesh conveyor belts 302, as shown, which they deliver the parts on the trays 301, or directly on the trays 301.

The trays 301 are then transported at first through an evaporation zone 303 and then through a drying and/or baking zone 305, heated directly with a heating system 304, the speed being adapted to the particular coating requirements, and then taken to a cooling zone 306, where they cool down. The evaporation zone 303 is preferably heated only indirectly by the heating system 304.

In the drying device 300 shown, the drying and/or baking zone 305 and the unheated cooling zone 306 are located one behind the other on the same level and are separated from each other by a wall—preferably a thermally insulating wall. A tray transport device 307 is provided for taking the trays from the drying and baking zone 305 to the unheated cooling zone 306.

The trays are then tilted up, which may occur again into containers 10, 10′, if a further processing is to occur. The containers 10, 10′ used here may also be fresh containers, which were not used in the coating device 200 and/or which are taken to a different coating device.

Since the drying device 300, as can be surmised in FIG. 1, is usually the largest of the devices belonging to the coating layout 1 in terms of its space requirement, an adapting of the coating layout 1 to the available space requirements and surrounding conditions can be achieved in particular by a variation of its geometry.

For example, at the end of the drying and/or baking zone 305 the trays 301 are taken for example by an elevator system to a level situated below the level in which the evaporation zone 303 and the drying and/or baking zone 305 are situated, where the cooling zone 306 is situated, in which the trays are cooled down during the return transport.

Alternatively, however, it may also be provided that the optionally divided trays 301 move not in linear fashion, but in a circle, which can be realized by a turn-table, as well as a conveyor belt. As with the drying device 300, a drying and/or baking zone and a cooling zone are provided. These zones may also be situated in two different levels, especially above or below each other, between which the trays can move with an elevator.

What all the drying devices just discussed have in common is that the loading and unloading of the drying device occurs on the same side, which affords the benefit that the same container handling system 500 can be used for the loading and the unloading process and the containers 10 can be supplied once more to the coating device 200 without long distances in cases where a multilayered coating is desired.

Basically, of course, the possibility also exists of providing the trays 301 with container receiving positions in which they are placed by the container handling system 500, instead of emptying the containers 10 onto the trays 301, so that the parts being coated are dried in the container 10.

Finally, the functioning of one possible preferred emptying device 400 shall be explained with reference to FIGS. 1 and 2. As these figures show, the emptying device 400 comprises an L-shaped support arm 402, which is mounted at the end of the short beam of the L and able to rotate about an axis A8 running horizontal to the floor level and substantially parallel to the long beam of the L—preferably driven by a motor. In this way, an eccentric swivel axle is provided, which reduces the drop height of the coated parts when emptied from the containers 10 and thus prevents any damaging of the coating during the emptying process.

In the long beam 402b of the L there are arranged two carrier plates 403a, 403b, preferably being rotatably mounted, which can be placed in rotation about the axes A9, A10 for example by a toothed belt from a motor, which is arranged on the short beam of the L, while optionally an oppositely directed rotation can be provided by a gearing.

The container receiving position 401 is configured as follows: each time bracing elements 407 are arranged on the carrier plates 403a,03b so that containers 10 can be placed on their flat top sides, facing away from the carrier plates 403a, 403b, and optionally secured, for example by clamping or by retaining brackets, while the space between carrier plates 403a, 403b and the bottoms of the containers 10 forms clearances 408 into which the container carrier 504 of the container handling system 500 can enter in order to set down containers 10 on the container receiving position 401, more precisely, on its bracing elements 407, and receive them from this.

For the emptying, the L-shaped support arm 402 is swiveled about the axis A8, while the containers 10 are optionally additionally placed in rotation about the axes A9, A10, possibly in opposite turning direction, in order to assist the emptying of the containers 10, for example onto a conveyor belt 409.

### LIST OF REFERENCE NUMBERS

1 Coating layout
10, 10′ Container
100 Filling device
101 Container receiving position
102 Plate
110 Bin
111 Discharge port
200 Coating device
201 Container receiving position
202 Frame
202a,202b Side piece
202c Middle beam
203 Axis
204 Motor
205 Rotor
206,206′ Axis
208,208′ Driving wheel
209,209′ Toothed belt
210 Gear wheel
211 Toothed belt
212 Pinion
213 Motor
220,220′ Holder
221 Actuating element
222 First plate
223 Strut
224 Second plate
225 Retaining bracket
226 Actuating section
227 Compression spring
228 End section
229 Hook-shaped section
230 Actuating device
231 Opening
240 Reservoir
241 Coating liquid
242 Receiver
243 Spray protection wall
244 Motor
245 Drive
250 Stand
300,300′,300″ Drying device
301 Tray
302 Wire mesh conveyor belt
303 Evaporation zone
304 Heating
305 Drying and/or baking zone
306 Cooling zone
307 Tray transport device
400 Emptying device
401 Container receiving position
402 Support arm
403a,403b Carrier plates
404a,404b Axis
405 Toothed belt
406 Motor
407 Bracing element
408 Clearance
409 Conveyor belt
500 Container handling system
501 Foot
502 Column
503 Mount
504 Container carrier
505 Rail system
A1,A2,A3,A4,A5,A6,A7,A8, A9,A10 Axis of rotation

1. A coating method, comprising:
dipping a container filled with parts being coated into a section of a reservoir filled with a coating liquid, wherein the container has a pierced container wall;
lifting the container filled with the parts being coated out from the coating liquid and
dispersing and/or spinning off excess coating liquid remaining on the parts being coated after lifting the container filled with the parts being coated out from the coating liquid;
wherein during the dispersing and/or spinning off of excess coating liquid remaining on the parts being coated after lifting the container filled with the parts being coated out from the coating liquid, rotating the container filled with the parts being coated for a time about an axis of rotation situated inside the container filled with the parts being coated and for a time about an axis of rotation situated outside the container filled with the parts being coated and running parallel to the axis of rotation situated inside the container filled with the parts being coated.

2. The coating method as claimed in claim 1, wherein, while the container filled with the parts being coated is being dipped into the coating liquid, rotating the container filled with the parts being coated for a time about the axis situated inside the container filled with the parts being coated and/or for a time about the axis situated outside the container filled with the parts being coated and running parallel to the axis situated inside the container filled with the parts being coated.

3. The coating method as claimed in claim 1, wherein the container filled with the parts being coated is rotated for a time simultaneously about the axis situated inside the container filled with the parts being coated and about the axis situated outside the container filled with the parts being coated and running parallel to the axis situated inside the container filled with the parts being coated.

4. The coating method as claimed in claim 1, wherein direction and speed of rotation about the axis situated inside the container filled with the parts being coated and direction and speed of rotation about the axis situated outside the container filled with the parts being coated are controlled independently of each other.

5. The coating method as claimed in claim 1, wherein two containers filled with the parts being coated are present, being arranged jointly on a rotor, wherein the axis situated inside the container filled with the parts being coated is a center axis of the respective container, and the axis situated outside the container filled with the parts being coated is a center axis of the rotor which is equidistant from the two center axes.

6. The coating method as claimed in claim 1, wherein the dipping of containers filled with the parts being coated into the section of the reservoir filled with the coating liquid occurs by a lifting movement of the reservoir.

7. A coating system, comprising:
a container filled with the parts to be coated, having a pierced container wall, the container configured to accept parts being coated;
a holder onto which the container is hung such that the container can be rotated by a first drive unit about an axis situated inside the container filled with the parts being coated;
a reservoir for a coating liquid and into which the container filled with the parts being coated can be dipped,
wherein the holder is arranged on a rotor, which can be rotated by a second drive unit, independent of the first drive unit, about an axis of rotation situated outside the container filled with the parts being coated and running parallel to the axis of rotation situated inside the container filled with the parts being coated.

8. The coating system as claimed in claim 7, wherein two containers filled with the parts being coated are present, being arranged jointly on the rotor, the axis situated inside the container filled with the parts being coated is the center axis of the respective container, and the axis situated outside the container filled with the parts being coated is a center axis of the rotor which is equidistant from the two center axes.

9. The coating system as claimed in claim 7, wherein the rotor is arranged rotatably on a carrier structure, which can swivel about an axis running parallel to the floor.

10. The coating system claim 7, wherein the reservoir is movably arranged so that a height at which the reservoir is situated relative to a floor can be changed by moving the reservoir.

11. The coating system claim 7, wherein the holder comprises a clamp for firmly clamping the container.

12. (canceled)

13. The system as claimed in claim 7,
further comprising a filling device for the filling of containers filled with the parts to be coated, an emptying device for emptying the containers filled with the parts to be coated, a drying device, or a combination thereof.

14. The system as claimed in claim 13,
further comprising a container handling system for the transport of the containers between and for handing off the containers to devices belonging to the system.

15. The system as claimed in claim 14, wherein the devices belonging to the system are arranged in a circle around the container handling system.
